(19) United States
(12) Patent Application Publication
(10) Pub. No.: US 2015/0201299 A1
(43) Pub. Date: Jul. 16, 2015

(54) Augmented Audio World

(71) Applicant: Gface GmbH, Frankfurt/Main (DE)

(72) Inventor: Cevat Yerli, Frankfurt/Main (DE)

(21) Appl. No.: 14/157,066

(22) Filed: Jan. 16, 2014

(51) Int. Cl. H04W 4/02

(52) U.S. Cl. CPC H04W 4/02

(57) ABSTRACT

A method comprises receiving an indication of a geographical location from a user, searching a database for the geographical location to retrieve at least one audio file associated with the geographical location and presenting, to the user, the at least one audio file. In some embodiments, the geographical location is a current location of the user. Another method comprises detecting, by an access device, a current location of a user, recording, by the access device, audio data, and storing the recorded audio data along with the detected current location in a database. In addition, computer-readable media, access devices and apparatus are described.

### FIELD

The present disclosure relates to methods, computer-readable media, and apparatus for providing an improved audio immersion experience.

### BACKGROUND

In current online systems, it is often possible for a user to leave a text message that may be read online by other users, such as the user's friends or fans. However, usually, it is only possible for the user to leave a message in the form of a standard text. For example, a first user, Michael, may be travelling in Peru and may post in a blog, or another text system, that he is currently at Machu Picchu and enjoys the great Inca monuments. In case one of Michael's friends subsequently comes to Machu Picchu, he or she may browse Michael's blog to find the entry about Machu Picchu to learn about Michael's favorite monuments.

However, standard text-based systems only allow a very limited amount of information to be transferred, as the user's real views and impressions are difficult to capture in text alone, especially when using short-text based systems. It is thus desirable to provide a user with the possibility to leave or retrieve other kinds of information associated with particular locations.

### SUMMARY AND INITIAL DESCRIPTION

In a first aspect, the disclosure provides a method comprising: receiving an indication of a geographical location from a user, searching a database for the geographical location to retrieve at least one audio file associated with the geographical location, and presenting, to the user, the at least one audio file.

The user may thus listen to an audio file that is associated with a desired geographical location. Providing information in audio form has several advantages as compared to standard text-based systems. Firstly, the user does not need to look at a text and may rather look at the surroundings, such as the monuments at Machu Picchu. Secondly, when the user listens to an audio file previously spoken by one of the user's friend or a professional speaker, the user may learn more about the speaker's feelings and emotions with respect to the subject of the audio file, as compared to written texts. Thirdly, information that does not come in the form of words may be provided to the user, such as ambient sound, music, the sound of animals, etc.

In some embodiments, the user may enter a geographical location for which the user wants to receive information in the form of one or more audio files. A database holding a plurality of geographical locations and at least one audio file for each of the plurality of geographical locations is then searched in order to retrieve at least one audio file associated with the geographical location received from the user. The at least one retrieved audio file is then presented to the user.

In some instances, the step of presenting, to the user, the at least one audio file may comprise playing the audio file to the user. In particular, the at least one audio file may be played to the user using one or more loudspeakers and/or headphones.

The indication of the geographical location may, e.g., be received in the form of geographical coordinates, an address, the name of a famous landmark, or the like. In some instances, searching the database may comprise searching the database to retrieve at least one audio file that is associated with a geographical location that is within a predetermined distance from the received location. The predetermined distance may, e.g., be stored along with the geographical location in the database. Alternatively or additionally, the predetermined distance may be specified by the user. In some embodiments, the predetermined distance is 500 m, in particular, 100 m and, preferably, 50 m. In some cases, at least one of the audio files stored in the database may be associated with at least two different geographical locations.

In some embodiments, receiving an indication of a geographical location from a user comprises: presenting, to the user, indications of a plurality of locations; and receiving, from the user, a selection of one of the plurality of locations. The user may thus conveniently select one of the plurality of geographical locations displayed for him or her.

Indications of the plurality of locations may be presented to the user on a map, in a tree structure, or as a list. The list may, for example, be an ordered list, which may, for example, be ordered alphabetically, according to a number of available audio files for the particular location, a level of popularity of the location, etc. In embodiments in which the plurality of locations is presented on a map, the user may, in some instances, be allowed to zoom into the map. For example, the method may comprise presenting a world map first. The user may then select a more detailed view of the world map, such as a map of Australia. On the detailed view, the user may then select a geographical location, such as Brisbane.

Presenting indications of the plurality of locations in a tree structure may imply that a hierarchy of geographical locations is presented to the user. For example, first, a list of continents may be displayed to the user. From this list, the user may select, for example, the continent “Europe.” Subsequently, a list of countries on that continent, e.g., countries in Europe, is presented to the user. For example, the user may select the country “France” from that list. In a further step, a list of cities or other locations within the selected country may be presented to the user. For example, the user may select the location “Paris” from that list. The user will then be provided with audio files related to Paris or may, in some instances, be provided with one or more further options to select a location within Paris, such as the Louvre, Notre Dame cathedral, etc.

In some embodiments, the database holds a plurality of audio files for at least one geographical location, and the method comprises: presenting, to the user, indications of at least two of the plurality of audio files associated with the received geographical location; receiving, from the user, a selection of at least one of the at least two audio files of the plurality of audio files; and presenting, to the user, the selected at least one audio file. These embodiments accommodate the case in which more than one audio file is stored in the database for the particular geographical location received from the user. In some instances, the indications of the at least two of the plurality of audio files are presented in an order, such as an alphabetical order, an order according to a level of popularity of the audio files, etc. In some embodiments, the at least two audio files are presented in the form of one or more channels of audio files, and the user may select one or more of the presented channels. As described in more detail below, the channels may correspond to public channels, advertisement channels, or private channels of the user or of other users, etc.

In some embodiments, the method may comprise receiving a selection of two or more of the at least two audio files from the user, and the selected two or more audio files may be presented to the user in a temporally overlapping manner, for example, simultaneously. In some instances, presentation of the selected audio files may start at substantially the same time. For example, one of the audio files may refer to an ambient sound at the geographical location received from the user, such as the sound of the waves on the Maldives, while another selected audio file comprises vocal information about the history of the Maldives, a famous Maldives fairytale, a folk song, or the like.

In some embodiments, the method further comprises determining access privileges for the user and presenting, to the user, the at least one audio file when the user's access privileges match the at least one audio file. For example, some of the audio files stored in the database may only be accessible to members upon payment of a membership fee. A user may then pay the membership fee to gain access to one or more audio files or to one or more channels of audio files. Access to one or more of the audio files may thus be restricted to members. Whenever a user wants to access an audio file or a channel with restricted access, the method may comprise determining whether the user is a member or has otherwise access privileges for that audio file or channel. When the user's access privileges match the at least one audio file, the at least one audio file is presented to the user. Otherwise, when the user's access privileges do not match the at least one audio file, presentation of the at least one audio file to the user is prevented.

According to some embodiments, the database further stores an author for at least some of the audio files stored in the database, wherein, in particular, the at least one audio file is presented to the user when the author stored with the at least one audio file is linked to the user within an online social network. For example, the user may only have access to audio files that were authored by the user himself or one of the user's friends on the online social network. In the context of this disclosure, the term “friend” on the online social network may refer to any person, organization, group, etc., that is linked to the user in the online social network. They may be linked to the user by a direct connection or an indirect connection. In some instances, this may imply that the user has tagged himself as a fan or follower of that person, organization, or group.

In some embodiments, presenting the at least one audio file comprises presenting, to the user, at least one channel of audio files. As described above, the audio files in the database may be organized into channels. In other words, an audio file in the database may be associated with one or more channels. When an indication of a geographical location is received, the user may select one or more channels to browse through the audio files contained in that channel. The user may then select one or more of the audio files of one or more channels for presentation. In some instances, one of the audio files in a selected channel may be presented automatically, when the user's current location matches the geographical location associated with that audio file, as described below. In some embodiments, the at least one channel comprises at least one of a public channel, an advertisement channel, and a private channel. The private channel may be a personal channel of the user or of another user of the online social network.

In some embodiments, the method comprises receiving a selection of a channel from the user and presenting, to the user, at least one audio file associated with the selected channel automatically, when the user's current location matches a geographical location associated with the at least one audio file associated with the selected channel. The channel may be associated with a plurality of audio files, each being associated with a geographical location. Different audio files associated with a particular channel may, in particular, be associated with different geographical locations. In some instances, the user's current location may match a geographical location associated with the at least one audio file when the user's current location is within a predetermined distance from the geographical location as explained above. Alternatively or additionally, at least one audio file associated with the channel may be associated with two or more geographical locations.

In some embodiments, the indication of the geographical location corresponds to the user's current location, i.e., the method comprises receiving an indication of the user's current geographical location. For example, the user may use an access device, such as a mobile phone, a laptop, a smartphone, etc., which is equipped with a position sensor to detect the user's current location. The user's current location may, e.g., be detected periodically and/or automatically. The database may then be searched for the user's current location to retrieve one or more audio files associated with the user's current location. In some instances, the user's current location is periodically detected and the database is periodically and/or automatically searched to retrieve audio files associated with the detected location. For example, the user may currently be in the Louvre in Paris, France, and activate an application on his or her smartphone. The application will then use the smartphone's position sensor to detect the user's current position. The user's current position, e.g., the location of the Louvre, may then be used to search the database for audio files associated with the Louvre, such as a guide through a particular exhibition, a brief history of the building, etc. In some embodiments, the current geographical location is detected and/or the database is searched periodically with a period of between 1 s and 200 s, in particular, between 5 s and 100 s and, preferably, between 10 s and 60 s.

In another example, the application may be running and the user has selected a channel of audio files associated with a city guide of Paris. The user's smartphone periodically detects its current location using an integrated GPS sensor and automatically searches the database using the detected location. Whenever the user comes within a predetermined distance from a monument on his or her walk through the city, audio files associated with the monument's location are retrieved from the database and are automatically presented to the user. The user may stop this procedure, e.g., by terminating the application.

In some embodiments, the audio files comprise only audio data. For example, the audio files may, in some instances, not comprise any video information. These embodiments may be advantageous, as the user is not required to look at a display to grasp all of the presented information, and may rather look at his or her surroundings.

In a further aspect, a method is provided which comprises: detecting, by an access device, a current location of the user; recording, by the access device, audio data; and storing the recorded audio data along with the detected current location in a database.

For example, an access device, such as a laptop, a computer, a handheld device, a mobile phone, a smartphone, a personal digital assistant (PDA), or the like may detect a current location of the user by using a position sensor integrated into or coupled to the access device, such as a GPS sensor. In some instances, the access device may record the audio data using a microphone integrated into or coupled to the access device.

In some embodiments, the database is stored in a memory integrated into or coupled to the access device. The memory may comprise a volatile or a non-volatile memory, such as flash memory, RAM, DRAM, SRAM, a hard disk, a solid state device (SSD), a memory card, such as an SD card, or other types of memory.

In some embodiments, the method further comprises transmitting the detected current location and the recorded audio data from the access devices to a server and the database is stored at the server. For example, the server may comprise or be coupled to a memory storing the database, such as a memory of the above-mentioned type.

The step of transmitting the detected current location and the recorded audio data from the access device to the server may be using a wired or a wireless communication link between the access device and the server. For example, the access device and the server may be coupled via the Internet.

In some embodiments, the method further comprises: receiving, from a second access device, a geographical location; searching the database for the received geographical location to retrieve at least one audio file associated with the geographical location; and presenting, by the second access device, the at least one audio file.

In embodiments, in which the database is stored in a memory integrated into or coupled to a server, the second access device and the server may be coupled to each other in wireless and/or wired communication, such as via the Internet. The geographical location may, in some instances, be a current location of the second access device as, e.g., detected by a position sensor integrated into or coupled to the second access device, such as a GPS sensor. Alternatively, the geographical location may be a geographical location entered or selected by a user of the second access device. To this effect, the second access device may comprise input means, such as a keyboard or a touchscreen.

In some embodiments, recording audio data comprises at least one of recording an ambient sound of the access device and a vocal message from the user. For example, the access device may record an ambient sound, such as the sound of the second access device's surroundings. Alternatively or additionally, the user may verbally speak a message that is recorded by the access device. For example, the user may say something of interest about his or her current location, sing a song that is related to the user's location, etc. That information is then recorded and stored in the database along with the user's current location.

In a further aspect, a computer-readable medium is provided, storing instructions that, when they are executed by a computer, cause the computer to perform a method of any of the aforementioned kinds.

For example, a computer-readable medium is provided, storing instructions that, when they are executed by a processor, cause the processor to perform a method of receiving an indication of a geographical location from a user; searching a database for the geographical location to retrieve at least one audio file associated with the geographical location; and presenting, to the user, the at least one audio file.

Moreover, a computer-readable medium is provided, storing instructions that, when they are executed by a processor of an access device, cause the processor to perform a method of: detecting, by the access device, a current location of a user; recording, by the access device, audio data; and storing the detected current location and the recorded audio data in a database.

These methods may further comprise any feature or combination of features of the methods described above.

In a further aspect, an apparatus is provided, comprising: a network interface adapted to couple to a first access device; a memory storing a database holding a plurality of geographical locations and associated audio files; and logic coupled to the network interface and to the memory. The logic may be adapted to receive a first geographical location and an audio file from the first access device via the network interface and to store the received first geographical location along with the audio file in the database.

In some embodiments, the network interface is adapted to be coupled to the first access device in wired and/or wireless communication, in particular, via the Internet.

The logic may, in some instances, be further adapted to: receive a second geographical location from a second access device coupled to the network interface; search the database for the received second geographical location to retrieve at least one audio file associated with the second geographical location; and provide the at least one audio file to the second access device. The second access device may be adapted to present the at least one audio file provided by the apparatus via the network interface to a user of the second access device, e.g., using loudspeakers or headphones integrated into or coupled to the second access device. In some instances, the second access device may be identical to, or may be of a same or a different type as compared to the first access device. For example, at least one of the first and second access devices may comprise a handheld device, a laptop computer, a personal computer, a smartphone, a personal digital system (PDA), or the like. The second access device may be coupled to the network interface in wired and/or wireless communication, such as via the Internet.

In some embodiments, the at least one audio file is selected from a group consisting of tourist information, city guides, advertisements, music, ambient sound, and tour guides.

### DESCRIPTION OF THE DRAWINGS

The present disclosure is best understood from the following detailed description when read in conjunction with the accompanying figures, in which:

FIG. 1 is a schematic diagram showing an apparatus according to an embodiment along with two access devices; and

FIG. 2 shows an illustrative view of a database according to an embodiment.

### DETAILED DESCRIPTION

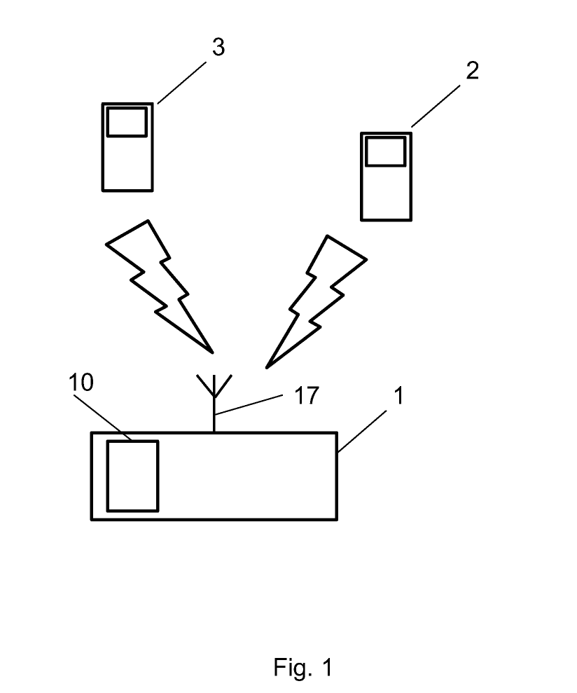

FIG. 1 shows an apparatus 1 according to an embodiment of the present disclosure. The apparatus 1 comprises a memory storing a database 10 and a network interface 17. The memory of the apparatus 1 storing the database 10 may, for example, comprise a hard disk. The network interface 17 of apparatus 1 may further be adapted to be coupled in wireless communication with a first access device 2 and a second access device 3. The first and second access devices 2, 3 may each be one of a smartphone, a mobile device, a handheld computer, a personal computer, a laptop computer, a personal digital assistant, or the like.

The user of the first access device 2 may, for example, start an application on the first access device 2 that detects a current geographical location of the first access device 2, for example, by means of a position sensor (not shown) integrated into the first access device 2, such as a GPS sensor. Moreover, the first access device 2 may comprise a microphone (not shown) to record an audio file. The application started by the user on the first access device 2 may detect the first access device's geographical location using the position sensor and may record an audio file using the microphone and transmit both to the apparatus 1, where they are received via the network interface 17. Alternatively, the first access device 2 may allow the user of the first access device 2 to manually or verbally enter a geographical location and/or to specify a previously recorded audio file for transmission to the apparatus 1.

The apparatus 1 may then store the geographical location and the audio file received via the network interface 17 in the database 10.

Subsequently, another user may use the second access device 3 to request information about an object located at a particular geographical location. For example, an application may be running on the second access device 3 that allows a user to enter a geographical location or that may, preferably, automatically detect the second access device's current geographical location, e.g., using a position sensor (not shown) integrated into or coupled to the second access device 3. The received geographical location is then transmitted from the second access device 3 to the apparatus 1, where it is received via the network interface 17. The apparatus 1 then searches the database 10 for the geographical location received from the second access device 3 to retrieve one or more audio files associated with the received geographical location. When one or more audio files associated with the received geographical location are retrieved, they are sent to the second access device 3 via the network interface 17.

In some embodiments, when two or more audio files or channels of audio files are retrieved from the database 10, the user of the second access device 3 may select one of the retrieved audio files or channels for presentation. For example, only the audio files or channels selected by the user of the second access device 3 may be transmitted from the apparatus 1 to the second access device 3.

In some embodiments, the second access device 3 may comprise a position sensor (not shown) to detect the current location of the second access device 3. The application running on the second access device 3 may then be adapted to transmit the current location of the second access device 3 as detected by the position sensor to the apparatus 1, in order to receive one or more audio files or channels associated with the second access device's 3 current location. Detection of the current position and transmission thereof may, e.g., be performed periodically and/or automatically.

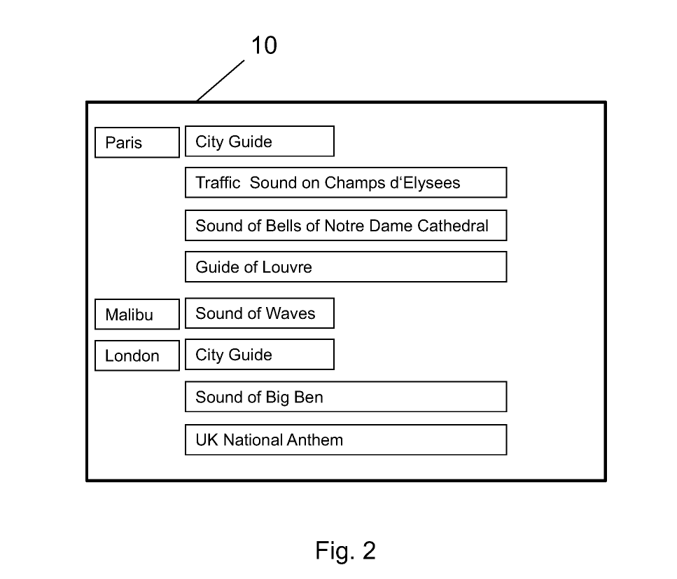

FIG. 2 shows a schematic view of the database, such as, for example, the database 10 of the apparatus 1 shown in FIG. 1. In the database 10, a number of geographical locations is stored, such as Paris, Malibu, and London, e.g., in the form of geographical coordinates or the like. For each of these geographical locations, one or more audio files and/or channels may be stored. For example, for the geographical location “Paris,” database 10 holds audio files labeled as “City Guide,” “Traffic Sound on Champs d'Elysees,” “Sound of Bells of Notre Dame Cathedral,” and “Guide of Louvre.” For the location of Malibu, however, database 10 only stores one audio file labeled “Sound of Waves” at Malibu.

When the user of the second access device 3 in FIG. 1 wishes to receive an audio file related to, for example, London, logic (not shown) included in the apparatus 1 may search the database 10 for the geographical location of “London.” In this case, the logic will retrieve audio files related to a city guide, the sound of Big Ben and the UK national anthem. In some embodiments, indications of these audio files are presented to the user of the second access device 3 for selection of one or more of them. Alternatively or additionally, all of the stored audio files associated with the location of “London” are transmitted from the apparatus 1 to the second access device 3. However, it is preferred that only indications of the available audio files or channels associated with the received geographical location are provided to the second access device 3, in order to avoid congestion of the communication link between the apparatus 1 and the second access device 3. The user of the second access device 3 may then, for example, select the “City Guide.” Subsequently, the apparatus 1 transmits the audio file “City Guide” associated with “London” to the second access device 3, which then presents the City Guide to the user, e.g., using headphones.

In some embodiments, the audio files stored in database 10 are organized in channels. For example, the database 10 may store a plurality of audio files associated with a channel “City Guide” of London, some of which may be associated with different locations within London. In these embodiments, the item “City Guide” not only refers to a single audio file, but to a channel comprising a plurality of audio files, each being associated with a particular location. In these embodiments, whenever a user has selected the channel “City Guide” of London, the second access device 3 may, subsequently, periodically and automatically detect the second access device's current location and, when the detected location is close to a stored geographical location of a monument, the location of which is stored in the database, automatically present an audio file that is associated with that monument. Hence, the user does not need to manually select a monument that he is approaching, but will rather automatically be provided with audio information with respect to the monument.

In the previous specification, features of one or more embodiments are described, such that a person skilled in the art may better understand the aspects of the present disclosure. Those skilled in the art will appreciate that the present disclosure may readably be used as a basis for designing or modifying other methods, apparatus, computer-readable medium, etc., for carrying out the same purposes and/or achieving the same advantages as the described embodiments. Those skilled in the art will also realize that such equivalent constructions do not depart from the spirit and scope of the present disclosure, and that they may make various changes, substitutions and modifications without departing from the spirit and scope of the present disclosure.

The embodiments of the invention in which an exclusive property or privilege is claimed are defined as follows:

1. A method comprising:
receiving an indication of a geographical location from a user;
searching a database for the geographical location to retrieve at least one audio file associated with the geographical location; and
presenting, to the user, the at least one audio file.

2. The method of claim 1, wherein receiving an indication comprises: presenting, to the user, indications of a plurality of locations; and receiving, from the user, a selection of one of the plurality of locations.

3. The method of claim 2, wherein the indications of the plurality of locations are presented to the user on a map, in a tree structure, or as a list.

4. The method of claim 1, wherein the database holds a plurality of audio files for at least one geographical location, and wherein the method comprises:
presenting, to the user, indications of at least two of the plurality of audio files associated with the received geographical location;
receiving, from the user, a selection of at least one of the at least two of the plurality of audio files; and
presenting, to the user, the selected at least one audio file.

5. The method of claim 1, further comprising determining access privileges for the user and presenting, to the user, the at least one audio file when the user's access privileges match the at least one audio file.

6. The method of claim 1, wherein the database further stores an author for at least some of the audio files stored in the database, and wherein, in particular, the at least one audio file is presented to the user when the author stored with the at least one audio file is linked to the user within an online social network.

7. The method of claim 1, wherein presenting the at least one audio file comprises presenting, to the user, at least one channel of audio files.

8. The method of claim 7, further comprising: receiving a selection of a channel from the user and presenting, to the user, at least one audio file associated with the selected channel automatically, when the user's current location matches a geographical location associated with the at least one audio file associated with the selected channel.

9. The method of claim 7, wherein the at least one channel comprises at least one of a public channel, an advertisement channel, and a personal channel.

10. The method of claim 1, wherein the indication of the geographical location corresponds to the user's current location.

11. A method comprising:
detecting, by an access device, a current location of a user;
recording, by the access device, audio data; and
storing the recorded audio data along with the detected current location in a database.

12. The method of claim 11, further comprising transmitting the detected current location and the recorded audio data from the access device to a server, and wherein the database is stored at the server.

13. The method of claim 11, further comprising:
receiving, from a second access device, a geographical location;
searching the database for the received geographical location to retrieve at least one audio file associated with the received geographical location; and
presenting, by the second access device, the at least one audio file.

14. The method of claim 11, wherein recording audio data comprises at least one of recording an ambient sound of the access device's surrounding and a vocal message from the user.

15. An apparatus comprising:
a network interface adapted to couple to a first access device;
a memory storing a database holding a plurality of geographical locations and associated audio files; and
logic coupled to the network interface and to the memory, the logic adapted to receive a first geographical location and an audio file from the first access device via the network interface and to store the received first geographical location along with the audio file in the database.

16. The apparatus of claim 15, wherein the network interface is adapted to be coupled in wireless communication to the first access device, in particular, via the Internet.

17. The apparatus of claim 15, wherein the logic is further adapted to:
receive a second geographical location from a second access device coupled to the network interface;
search the database for the received second geographical location to retrieve at least one audio file associated with the second geographical location; and
provide the at least one retrieved audio file to the second access device via the network interface.

18. The apparatus of claim 17, wherein at least one audio file stored in the database is selected from a group consisting of: tourist information, city guides, advertisements, music, ambient sound, and tour guides.
